(19) United States
(12) Patent Application Publication
(10) Pub. No.: US 2018/0213202 A1
(43) Pub. Date: Jul. 26, 2018

(54) Generating a Video Stream from a 360-Degree Video

(71) Applicant: JAUNT INC., PALO ALTO, CA (US)

(72) Inventors: DANIEL KOPEINIGG, PALO ALTO, CA (US); RICARDO GARCIA, PALO ALTO, CA (US)

(21) Appl. No.: 15/413,412

(22) Filed: Jan. 23, 2017

(51) Int. Cl. H04N 13/00; H04N 13/04; H04N 19/167; H04N 19/187; H04N 19/162

(52) U.S. Cl. CPC H04N 13/0048; H04N 13/0059; H04N 19/162; H04N 19/167; H04N 19/187; H04N 13/0468

(57) ABSTRACT

A method includes receiving a 360-degree video. The method further includes determining one or more regions of interest (ROIs) within the 360-degree video. The method further includes, for each frame in the 360-degree video, splitting the frame into a base layer that includes at least a partial view of the 360-degree video and splitting the frame into one or more enhancement layers that correspond to the one or more ROIs. The method further includes receiving the base layer and, based on a viewing direction of an end user, the one or more enhancement layers. The method further includes generating a video stream from the base layer and, based on the viewing direction of the end user, the one or more enhancement layers. The method includes providing the video stream to a decoder for decoding.

### FIELD

The embodiments discussed herein are related to generating a video stream from a 360-degree video. More particularly, the embodiments discussed herein relate to generating a video stream from one or more base layers and one or more enhancement layers to display virtual reality content.

### BACKGROUND

Streaming 360-degree video content requires high-speed internet connections to deliver detail-rich video. 360-degree videos are typically larger than standard videos because they must be encoded at high resolutions to ensure that the 360-degree videos have sufficient details in all viewing directions. For example, 360-degree videos often have high angular resolutions (e.g., greater than 4k), high frame rates (e.g., greater than 30 frames per second), and/or stereoscopic/three-dimensional content.

When the 360-degree video is transmitted wirelessly, because wireless connections have limited bandwidth, the quality of the 360-degree video may suffer. One solution is to stream only a portion of the 360-degree video with high quality. A user typically only looks at about 20% of the 360-degree environment depicted by the 360-degree video at any moment. However, because the user may move and look in a different direction, the movement may result in the user perceiving a lag in the 360-degree video as a streaming server updates the direction and transmits the 360-degree video content for the different direction.

### SUMMARY

According to one innovative aspect of the subject matter described in this disclosure, a method includes receiving a 360-degree video. The method further includes determining one or more regions of interest (ROIs) within the 360-degree video. The method further includes, for each frame in the 360-degree video, splitting the frame into a base layer that includes at least a partial view of the 360-degree video and splitting the frame into one or more enhancement layers that correspond to the one or more ROIs. The method further includes receiving the base layer and, based on a viewing direction of an end user, the one or more enhancement layers. The method further includes generating a video stream from the base layer and, based on the viewing direction of the end user, the one or more enhancement layers. The method includes providing the video stream to a decoder for decoding.

In some embodiments, the method further includes encoding a first frame of the 360-degree video as a key frame. In some embodiments, encoding the first frame of the 360-degree video further includes encoding a first enhancement layer of the one or more enhancement layers as a reference frame that references the base layer. In some embodiments, the base layer and the one or more enhancement layers each include two or more views of the 360-degree video. In some embodiments, a first view of the 360-degree video is associated with the base layer and one enhancement layer and a second view of the 360-degree video is associated with the base layer and two enhancement layers. In some embodiments, the first view is a forward view and the second view is a backside view. In some embodiments, the viewing direction is a first viewing direction, the video stream is a first viewing stream, the one or more enhancement layers are one or more first enhancement layers that correspond to the first viewing direction, and further comprising: based on a second viewing direction of the end user, generating a second video stream from the base layer and one or more second enhancement layers and providing the second video stream to the decoder for decoding. In some embodiments, splitting the frame is based on at least one of spatial filtering, frequency filtering, and wavelet transformation. In some embodiments, the method further includes prefetching the one or more enhancement layers based on head-tracking data. In some embodiments, the head-tracking data describes a most-common viewing direction.

Other aspects include corresponding methods, systems, apparatus, and computer program products for these and other innovative aspects.

The disclosure is particularly advantageous in a number of respects. First, the disclosure describes a way to achieve low-latency frame switching that is not key-frame dependent. Second, the disclosure describes a way to avoid bandwidth spikes due to head movement. Third, the disclosure describes video streaming that is compatible with H264, H265, and other codecs. Fourth, the disclosure describes a way to reduce the overall bandwidth needed even if no head movement occurs. Lastly, the disclosure describes video streaming that works with only one decoder.

### BRIEF DESCRIPTION OF THE DRAWINGS

FIG. 1 illustrates an example virtual reality system that generates a video stream from a 360-degree video according to some embodiments.

FIG. 2 illustrates an example computing device that encodes the 360-degree video according to some embodiments.

FIG. 3 illustrates an example frame of a 360-degree video with a base layer and two enhancement layers according to some embodiments.

FIG. 4 illustrates an example computing device that generates a video stream according to some embodiments.

FIG. 5 illustrates an example process for encoding and synthesizing virtual reality content from a 360-degree video according to some embodiments.

FIGS. 6A-6C illustrate another example process for encoding and synthesizing virtual reality content from a 360-degree video according to some embodiments.

FIG. 7 illustrates an example flow diagram for generating a video stream from a 360-degree video according to some embodiments.

### DESCRIPTION OF EMBODIMENTS

The disclosure relates to generating a video stream from a 360-degree video. An encoding application receives a 360-degree video, such as a virtual reality video of a beach in Mexico. The encoding application determines one or more regions of interest within the 360-degree video. For example, the regions of interest may be based on historical viewing data that describes the location of users' eyes as they view the 360-degree video. For each frame in the 360-degree video, the encoding application splits the frame into a base layer that includes at least a partial view of the 360-degree video. The base layer may be a low-resolution version frame that includes all the pixels of a particular view. For each frame in the 360-degree video, the encoding application may generate one or more enhancement layers. The enhancement layer may be a high-resolution portion of the particular view. For example, the enhancement layer may include a high-resolution portion of a person that is standing on the beach in the 360-degree video. When the base layer and the enhancement layer are combined, the end user may see a frame of the beach with the waves being displayed at a low resolution and the person being displayed at a high resolution. Some views of the beach may only include the base layer, such as a view that only includes the waves.

The synthesizing application may receive the base layer and, based on a viewing direction of the end user, the one or more enhancement layers. For example, if the end user is looking at the waves, the synthesizing application may receive the base layer of the waves. Alternatively, if the end user is looking at a person in front of the waves, the synthesizing application may receive the base layer and one or more enhancement layers of the person in front of the waves.

The synthesizing application may generate a video stream from only the base layer or the base layer and the one or more enhancement layers, depending on the viewing direction of the end user. The synthesizing application sends the video stream to a decoder for decoding.

### Example System

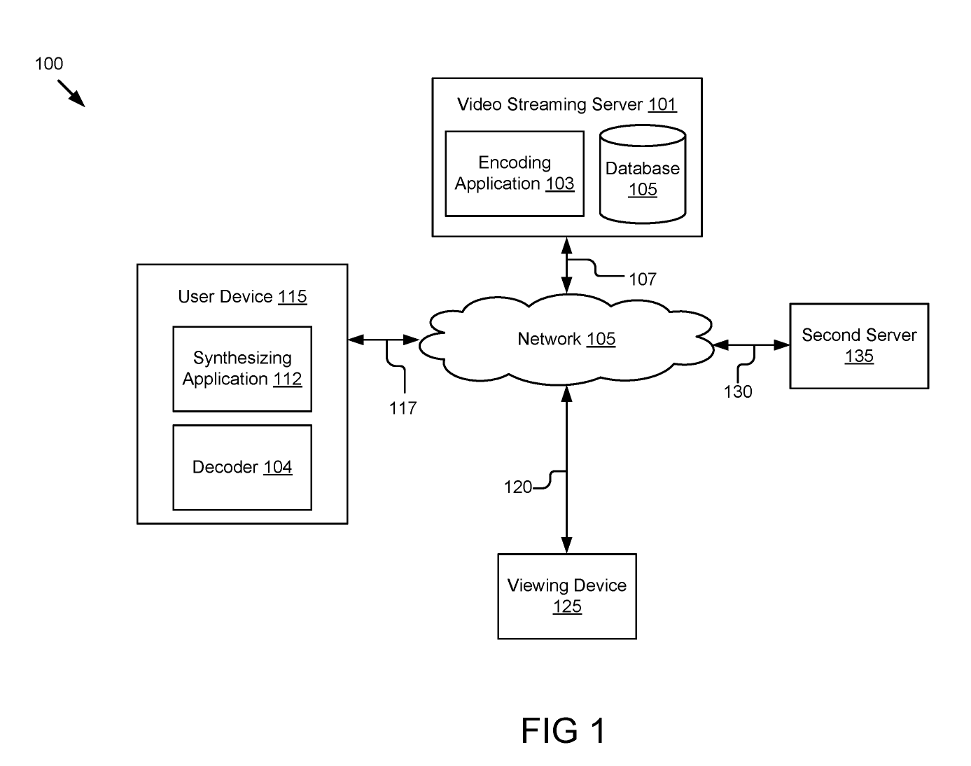

FIG. 1 illustrates an example virtual reality system 100 that generates a video stream from a 360-degree video. The virtual reality system 100 comprises a video streaming server 101, a user device 115, a viewing device 125, and a second server 135.

While FIG. 1 illustrates the encoding application 103 and the synthesizing application 112 as being stored on separate devices, in some embodiments, the encoding application 103 and the synthesizing application 112 may be the same application that is stored on either the video streaming server 101 or the user device 115. While FIG. 1 illustrates one video streaming server 101, one user device 115, one viewing device 125, and one second server 135, the disclosure applies to a system architecture having one or more video streaming servers 101, one or more user devices 115, one or more viewing devices 125, and one or more second servers 135. Furthermore, although FIG. 1 illustrates one network 105 coupled to the entities of the system 100, in practice one or more networks 105 may be connected to these entities and the one or more networks 105 may be of various and different types.

The network 105 may be a conventional type, wired or wireless, and may have numerous different configurations including a star configuration, token ring configuration, or other configurations. Furthermore, the network 105 may include a local area network (LAN), a wide area network (WAN) (e.g., the Internet), or other interconnected data paths across which multiple devices may communicate. In some embodiments, the network 105 may be a peer-to-peer network. The network 105 may also be coupled to or include portions of a telecommunications network for sending data in a variety of different communication protocols. In some embodiments, the network 105 may include Bluetooth™ communication networks or a cellular communication network for sending and receiving data including via hypertext transfer protocol (HTTP), direct data connection, etc.

The video streaming server 101 may be a hardware server that includes a processor, a memory, a database 105, and network communication capabilities. The video streaming server 101 may also include an encoding application 103. In some embodiments, the encoding application 103 can be implemented using hardware including a field-programmable gate array (“FPGA”) or an application-specific integrated circuit (“ASIC”). In some other embodiments, the encoding application 103 may be implemented using a combination of hardware and software. The video streaming server 101 may communicate with the network 105 via signal line 107.

The encoding application 103 may receive 360-degree video, determine one or more regions of interest, and encode the 360-degree video by splitting it into, for each frame, a base layer and, in some embodiments, one or more enhancement layers based on the one or more regions of interest. The database 105 may store one or more of 360-degree videos, data about regions of interest, base layers, and enhancement layers.

The user device 115 may be a processor-based computing device. For example, the user device 115 may be a personal computer, laptop, tablet computing device, smartphone, set top box, network-enabled television, or any other processor based computing device. In some embodiments, the user device 115 includes network functionality and is communicatively coupled to the network 105 via a signal line 117. The user device 115 may be configured to receive data from the video streaming server 101 via the network 105. A user may access the user device 115.

The user device 115 may include a synthesizing application 112 and a decoder 104. In some embodiments, the synthesizing application 112 and the decoder 104 can be implemented using hardware including a field-programmable gate array (“FPGA”) or an application-specific integrated circuit (“ASIC”). In some other embodiments, the synthesizing application 112 and the decoder 104 may be implemented using a combination of hardware and software. In some embodiments, the synthesizing application 112 and the decoder 104 are part of the same application.

The synthesizing application 112 receives the base layer and, depending on the viewing direction of an end user, one or more enhancement layers from the encoding application 103. Depending on the viewing direction of the end user, the synthesizing application 112 generates a video stream from the base layer and the one or more enhancement layers. The synthesizing application 112 provides the video stream to the user device 115.

The decoder 104 may decode the video stream received from the synthesizing application 112. The decoder 104 may provide the decoded video stream to the viewing device 125.

The viewing device 125 may be operable to display the decoded video stream. The viewing device 125 may include or use a computing device to render the video stream for the 360-degree video on a virtual reality display device (e.g., Oculus Rift virtual reality display) or other suitable display devices that include, but are not limited to: augmented reality glasses; televisions, smartphones, tablets, or other devices with three-dimensional displays and/or position tracking sensors; and display devices with a viewing position control, etc. The viewing device 125 may also render a stream of three-dimensional audio data on an audio reproduction device (e.g., a headphone or other suitable speaker devices). The viewing device 125 may include the virtual reality display configured to render the video stream of the 360-degree video and the audio reproduction device configured to render the three-dimensional audio data.

The viewing device 125 may be coupled to the network 105 via signal line 120. The viewing device 125 may communicate with the user device 115 and/or the video streaming server 101 via the network 105 or via a direct connection with the user device 115 (not shown). An end user may interact with the viewing device 125. The end user may be the same or different from the user that accesses the user device 115.

The viewing device 125 may track a head orientation of the end user while the end user is viewing the decoded video stream. For example, the viewing device 125 may include one or more accelerometers or gyroscopes used to detect a change in the end user's head orientation. The viewing device 125 may render the video stream of 360-degree video on a virtual reality display device based on the viewing direction of the end user. As the end user changes his or her head orientation, the viewing device 125 may adjust the rendering of the decoded video stream based on the changes of the viewing direction of the end user. The viewing device 125 may log head-tracking data and transmit the head-tracking data to the synthesizing application 112. Although not illustrated, in some embodiments the viewing device 125 may include some or all of the components of the encoding application 103, the synthesizing application 112, and the decoder 104 described below.

The second server 135 may be a hardware server that includes a processor, a memory, a database, and network communication capabilities. In the illustrated embodiment, the second server 135 is coupled to the network 105 via signal line 130. The second server 135 sends and receives data to and from one or more of the other entities of the system 100 via the network 105. For example, the second server 135 generates a 360-degree video and transmits the 360-degree video to the video streaming server 101. The second server 135 may include a virtual reality application that receives video data and audio data from a camera array and aggregates the video data to generate the 360-degree video.

### Example Encoding Application

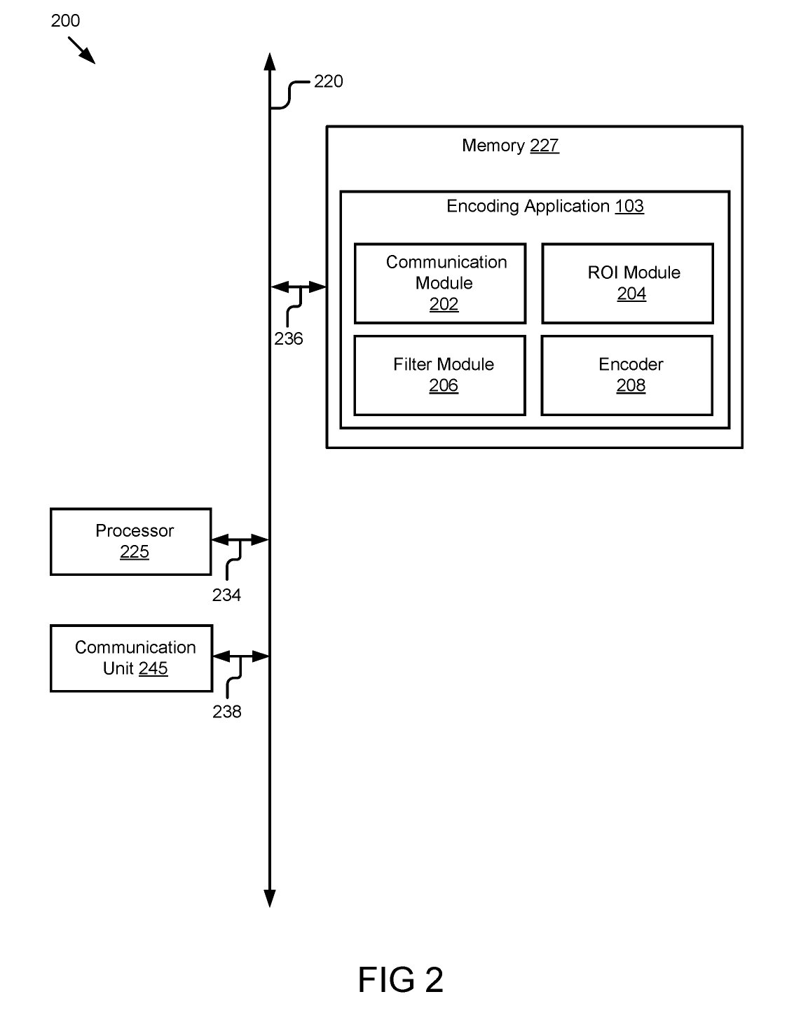

FIG. 2 illustrates an example computing device 200 that encodes the 360-degree video according to some embodiments. The computing device 200 may be the video streaming server 101 or the user device 115. In some embodiments, the computing device 200 may include a special-purpose computing device configured to provide some or all of the functionality described below with reference to FIG. 2.

FIG. 2 may include a processor 225, a memory 227, and a communication unit 245. The processor 225, the memory 227, and the communication unit 245 are communicatively coupled to the bus 220. Other hardware components may be part of the computing device 200, such as sensors (e.g., a gyroscope, accelerometer), a display, etc.

The processor 225 may include an arithmetic logic unit, a microprocessor, a general-purpose controller, or some other processor array to perform computations and provide electronic display signals to a display device. The processor 225 processes data signals and may include various computing architectures including a complex instruction set computer (CISC) architecture, a reduced instruction set computer (RISC) architecture, or an architecture implementing a combination of instruction sets. Although FIG. 2 includes a single processor 225, multiple processors may be included. Other processors, operating systems, sensors, displays, and physical configurations may be possible. The processor 225 is coupled to the bus 220 for communication with the other components via signal line 234.

The memory 227 stores instructions or data that may be executed by the processor 225. The instructions or data may include code for performing the techniques described herein. For example, the memory 227 may store the virtual reality application 103, which may be a series of modules that include instructions or data for generating three-dimensional videos.

The memory 227 may include a dynamic random access memory (DRAM) device, a static random access memory (SRAM) device, flash memory, or some other memory device. In some embodiments, the memory 227 also includes a non-volatile memory or similar permanent storage device and media including a hard disk drive, a flash memory device, or some other mass storage device for storing information on a more permanent basis. The memory 227 is coupled to the bus 220 for communication with the other components via signal line 236.

The communication unit 245 may include hardware that transmits and receives data to and from the video streaming server 101, the user device 115, the viewing device 125, and the second server 135. The communication unit 245 is coupled to the bus 220 via signal line 238. In some embodiments, the communication unit 245 includes one or more ports for direct physical connection to the network 105 or another communication channel. For example, the communication unit 245 includes a USB, SD, PCI, Ethernet, or similar port for wired communication with the computing device 200. In some embodiments, the communication unit 245 includes a wireless transceiver for exchanging data with the computing device 200 or other communication channels using one or more wireless communication methods, including IEEE 802.11, IEEE 802.16, Bluetooth®, or another suitable wireless communication method.

In some embodiments, the communication unit 245 includes a cellular communications transceiver for sending and receiving data over a cellular communications network including via hypertext transfer protocol (HTTP), direct data connection, or another suitable type of electronic communication. In some embodiments, the communication unit 245 includes a wired port and a wireless transceiver. The communication unit 245 also provides other conventional connections to the network 105 for distribution of files or media objects using standard network protocols including TCP/IP, UDP, HTTP, HTTPS, and SMTP, etc.

The encoding application 103 may include a communication module 202, a region of interest (ROI) module 204, a filter module 206, and an encoder 208. Other modules are possible. Although the modules are illustrated as being part of the same computing device 200, in some embodiments some of the modules are stored on the video streaming server 101 and some of the modules are stored on the user device 115. For example, the second server 135 may include the communication module 202, the ROI module 204, the filter module 206, and the encoder 208, while the user device 115 may include a user interface module.

The communication module 202 may include code and routines for processing 360-degree video. In some embodiments, the communication module 202 includes a set of instructions executable by the processor 225 to process 360-degree video. In some embodiments, the communication module 202 is stored in the memory 227 of the computing device 200 and is accessible and executable by the processor 225.

The communication module 202 may receive a 360-degree video via the communication unit 245. The communication module 202 may receive the 360-degree video from the second server 135. The communication module 202 may store the 360-degree video in the database 105.

The 360-degree video may include virtual reality content that depicts a 360-degree environment. For example, the virtual reality content may include video of physical locations that currently exist, physical locations that existed at some point in time, fictional locations, instructional videos, gaming environments, etc. The 360-degree video may include monoscopic, stereoscopic, or 3D data frames.

The ROI module 204 may include code and routines for determining one or more ROIs in the 360-degree video. In some embodiments, the ROI module 204 includes a set of instructions executable by the processor 225 to determine one or more ROIs. In some embodiments, the ROI module 204 is stored in the memory 227 of the computing device 200 and is accessible and executable by the processor 225.

A 360-degree video may be composed of multiple views. For example, the 360-degree video may be composed of four views: forward, backside, right, and left. In some embodiments, the ROI module 204 determines one or more ROIs within each view. For example, the ROI module 204 may determine that the front facing view is composed of four ROIs that are evenly divided within the forward view. In some embodiments, the ROI module 204 may perform object recognition to identify potential areas with ROIs. For example, the ROI module 204 may automatically determine that images of people are ROIs.

In some embodiments, the ROI module 204 may determine one or more ROIs based on head-tracking data. The ROI module 204 may receive head tracking data from the viewing devices 125 that were used by people who viewed the 360-degree video. The head tracking data may describe a person's head movement as the person watches the 360-degree video. For example, the head tracking data may reflect that a person moved her head up and to the right to look at an image of a squirrel in a tree. In some embodiments, the head tracking data includes yaw (i.e., rotation around a vertical axis), pitch (i.e., rotation around a side-to-side axis), and roll (i.e., rotation around a front-to-back axis) for a person as a function of time that corresponds to the 360-degree video.

In some embodiments, the ROI module 204 generates user profiles based on the head tracking data. For example, the ROI module 204 may aggregate head tracking data from multiple people and organize it according to a first most common region of interest in the 360-degree video, a second most common region of interest in the 360-degree video, and a third most common region of interest in the 360-degree video. In some embodiments, the ROI module 204 may generate user profiles based on demographic information corresponding to the people. For example, the ROI module 204 may generate a user profile based on age, gender, etc. In some embodiments, the ROI module 204 may generate a user profile based on physical characteristics. For example, the ROI module 204 may identify people that move frequently while viewing the three-dimensional video and people that move very little. In some embodiments, the ROI module 204 generates a user profile for a particular user.

The filter module 206 may include code and routines for splitting frames in the 360-degree video. In some embodiments, the filter module 206 includes a set of instructions executable by the processor 225 to split the frames in the 360-degree video. In some embodiments, the filter module 206 is stored in the memory 227 of the computing device 200 and is accessible and executable by the processor 225.

For each frame in the 360-degree video, the filter module 206 splits the frame into one or more base layers that include at least a partial view of the 360-degree video. The filter module 206 may also split each frame into one or more enhancement layers that correspond to the one or more ROIs determined by the ROI module 204.

In some embodiments, the filter module 206 divides the 360-degree video into multiple views. The views may be a division of the 360-degree video, such as four views of the 360-degree video. Alternatively, the summation of the multiple views may be less than 360 degrees to save additional bandwidth, power-consumption, increase resolution, or to avoid end-device compatibility issues. In some embodiments, the views may include different shapes and sizes, such as tiles, ovals, etc. In some embodiments, the 360-degree video may be divided into views with different shapes and sizes, such as a rectangular front view, an oval upward view, etc. In some embodiments, the multiple views may overlap with each other.

The filter module 206 splits each frame into one or more base layers that include one or more of the multiple views. The filter module 206 may also split one or more of the multiple views into one or more enhancement layers that correspond to the one or more ROIs determined by the ROI module 204. If one of the views does not include a ROI, such as the example above where the view only includes the water on the beach, the ROI module 204 may only split the view into a base layer and not into one or more enhancement layers. In yet another example, the ROI module 204 may split a first view of the 360-degree video into one base layer and one enhancement layer and a second view of the 360-degree video into one base layer and two enhancement layers. Each successive enhancement layer builds on top of the previous layers and includes a higher resolution version of the frame than the previous layers.

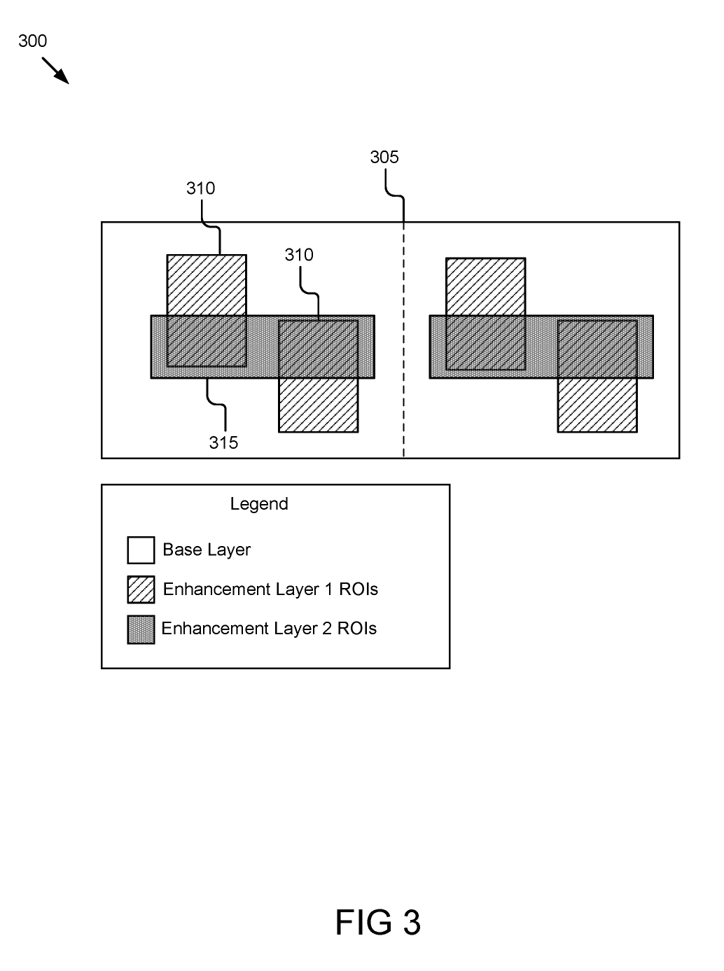

FIG. 3 illustrates an example frame 300 of a 360-degree video with a base layer and two enhancement layers. In this example, the frame 300 is divided into two views as demarcated by the dashed line 305. Each view includes a base layer and two enhancement layers. Each enhancement layer enhances a portion of the frame that is smaller than the base layer. For example, in FIG. 3 enhancement layer 1 310 may enhance a portion of the base layer that corresponds to people in the 360-degree video. Enhancement layer 2 315 may enhance a portion of the base layer that corresponds to the faces of the people in the 360-degree video. Enhancement layer 2 315 also enhances a portion of the base layer that was not enhanced by enhancement layer 1 310. The filter module 206 may split the 360-degree video into enhancement layer 1 310 and enhancement layer 2 315 because the enhancement layers include the ROIs and an end user may want to see greater detail of the people and even greater detail of the peoples' faces.

In some embodiments, the filter module 206 splits the frame using spatial filtering, frequency filtering, or wavelet transformation. Spatial filtering includes splitting a base layer that is composed of multiple views. Frequency filtering includes dividing the frame into gradations of frequencies, such as low frequencies, medium frequencies, and high frequencies. The filter module 206 may split the frame using a 2D wavelet transform, an arrangement of two-dimensional image low-pass and multiple bandpass arrangements, or discrete cosine transform based filtering.

In some embodiments, the filter module 206 splits the frames of the 360-degree video (INPUT) and the encoder 208 encodes the base layer and one or more enhancement layers (if available) using the following algorithm:

FOR EACH frame in INPUT:
Split INPUT→BaseLayer (BL), N enhancement layers using spatial filtering, frequency filtering, or wavelet transformation.
Split→BaseLayer (BL) (K) in K-views [Note: k can be 0 . . . K−1]
Split→EnhancementLayers in N Layers (EL) (T,N) and T-views [Note: t can be 0 . . . T−1]
FOR EACH k[0 . . . K−1]:
   Encode BL(k)→eBL(k)
FOR EACH n[0 . . . N−1]:
FOR EACH t[0 . . . T−1]:
IF (n==0)
   EncodeReference EL(t,0) from corresponding eBL(k)→eEL(t,0)
ELSE
   EncodeReference EL(t,n) from eEL(t,n−1)→eEL(t,n)
ENDIF
DO
DO
DO
DO
Function Split: INPUT→BL(K), (EL) (T,N)
Function Encode: Encodes into a playable video
Function EncodeReference: Encodes with a specific reference frame Pseudo-Reconstruction:
GETIndx(Layer, Gaze)→eV
# Returns associated view Index for Layer, viewingDIRECTION
Image(gaze)=BL(GETIndx (‘BL’, gaze))+Σᵢ₌₀^{L}E(1,GETIndx(‘E(1)’, gaze))

The encoder 208 may include code and routines for encoding base layers and enhancement layers. In some embodiments, the encoder includes a set of instructions executable by the processor 225 to encode the base layers and the enhancement layers. In some embodiments, the encoder is stored in the memory 227 of the computing device 200 and is accessible and executable by the processor 225.

The encoder 208 encodes the base layer as a regular playable video file with any choice of group of pictures (GOP) size. A GOP specifies an order in which key frames and reference frames are arranged as a collection of successive frames within a coded video stream. In some embodiments, the key frame is an I-frame and the reference frames are P-frames. I-frames are the least compressible type of frame, but are not dependent on other frames to be decoded and rendered as a frame of a video stream. P-frames include only the changes between a current frame and a previous frame. P-frames are advantageous because they are much less data intensive than I-frames. Other types of reference frames may be used, such as B-frames.

The encoder 208 encodes the base layer with a key frame and a sequence of reference frames that each reference a subsequent frame of the base layer (BL). In some embodiments, the encoder 208 encodes the enhancement layers with reference frames that describe the changes in resolution between the base layer and the enhancement layers for a similar frame in time. Table 1 below includes an example of how the key frame and the reference frames (RF) may be encoded by the encoder 208.

TABLE 1

| | | Enhancement Layer | Enhancement Layer | Enhancement Layer |
|---|---|---|---|---|
| Frame # | Base Layer (BL) | 1/First View (E/V0) | 2/First View (E + 1/V0) | 1/Second View (E/V1) |
| 0 | (BL)#0 (Key | RF from (BL)#0 | RF from (E/V0)#0 | RF from (BL)#0 |
| | frame) | | | |
| 1 | RF from (BL)#0 | RF from (BL)#1 | RF from (E/V0)#1 | RF from (BL)#1 |
| 2 | RF from (BL)#1 | RF from (BL)#2 | RF from (E/V0)#2 | RF from (BL)#2 |
| 3 | RF from (BL)#2 | RF from (BL)#3 | RF from (E/V0)#3 | RF from (BL)#3 |
| 4 | RF from (BL)#3 | RF from (BL)#4 | RF from (E/V0)#4 | RF from (BL)#4 |
| . . . | . . . | . . . | . . . | . . . |
| N | RF from (BL)#N | RF from (BL)#N | RF from (E/V0)#N | RF from (BL)#N |

In this example, each frame is associated with a base layer (BL), a first enhancement layer for a first view, a second enhancement layer for a first view, and a first enhancement layer for a second view. The base layer includes the key frame (e.g., an I-frame). The first enhancement layer for the first view includes a reference frame that references the base layer. The second enhancement layer for the first view references the reference frame from the first enhancement layer for the first view. The first enhancement layer for the second view references the reference frame that references the base layer.

### Example Synthesizing Application

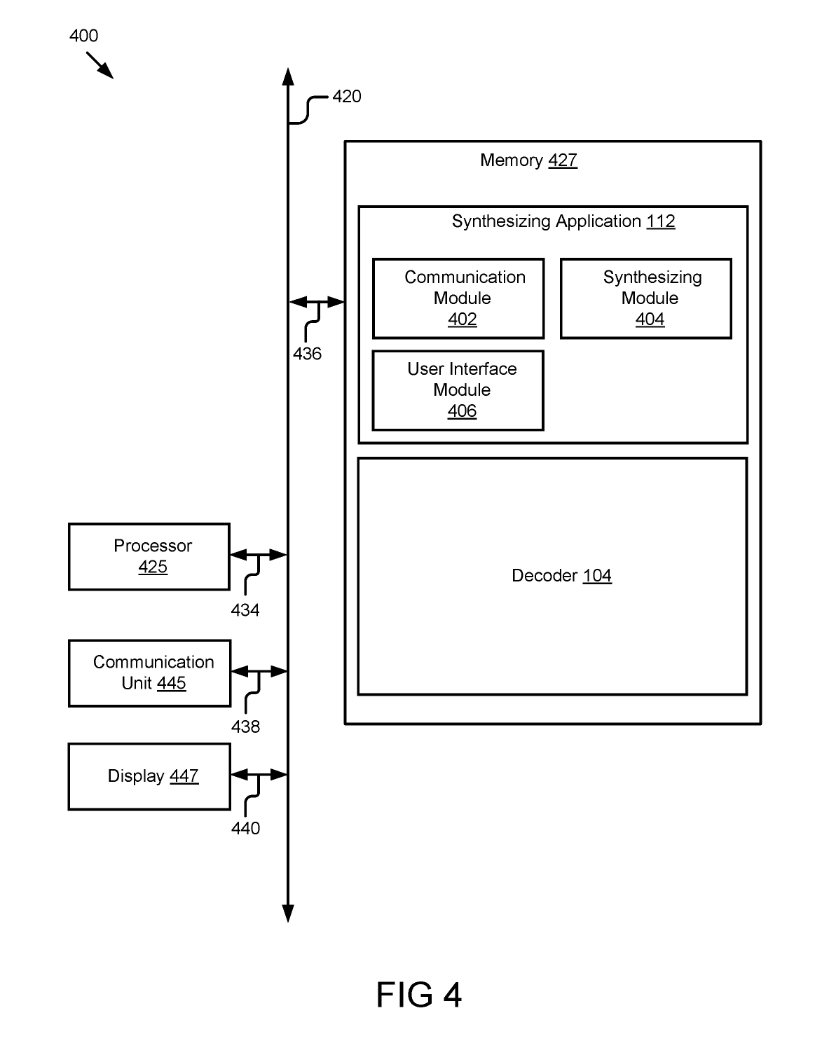

FIG. 4 illustrates an example computing device 400 that generates a video stream according to some embodiments. The computing device 200 may be the user device 115 or the video streaming server 101. In some embodiments, the computing device 400 may include a special-purpose computing device configured to provide some or all of the functionality described below with reference to FIG. 4.

FIG. 4 may include a processor 425 that is coupled to the bus 420 via signal line 434, a memory 427 coupled to the bus 420 via signal line 436, a communication unit 445 that is coupled to the bus 420 via signal line 438, and a display 447. Other hardware components may be part of the computing device 200, such as sensors (e.g., a gyroscope, accelerometer), etc. Because a memory, a processor, and a communication unit were described with reference to FIG. 2, they will not be described separately here. The memory 427 stores a synthesizing application 112 and a decoder 104. In some embodiments, the synthesizing application 112 and the decoder 104 may be part of the same application.

The display 447 may include hardware for displaying graphical data related to the synthesizing application 112 and the decoder 104. For example, the display 447 displays a user interface module 406 for selecting a 360-degree video to be displayed by the viewing device 125. The display 447 is coupled to the bus 420 via signal line 440.

The synthesizing application 112 includes a communication module 402, a synthesizing module 404, and a user interface module 406.

The communication module 402 may include code and routines for processing a base layer, one or more enhancement layers, and a viewing direction of an end user. In some embodiments, the communication module 402 includes a set of instructions executable by the processor 425 to process the base layer, the one or more enhancement layers, and the viewing direction of the end user. In some embodiments, the communication module 402 is stored in the memory 427 of the computing device 400 and is accessible and executable by the processor 425.

In some embodiments, the communication module 402 receives a viewing direction of an end user from the viewing device 125 via the communication unit 445. The viewing direction describes the position of the end user's head while viewing the 360-degree video. For example, the viewing direction may include a description of yaw (i.e., rotation around a vertical axis), pitch (i.e., rotation around a side-to-side axis), and roll (i.e., rotation around a front-to-back axis). The communication module 402 may receive the viewing direction from the viewing device 125 periodically (e.g., every one second, every millisecond, etc.) or each time there is a change in the position of the end user's head.

The communication module 402 receives the base layer for each of the frames from the encoding application 103 via the communication unit 445. Based on the viewing direction of the end user, the communication module 402 may also receive one or more enhancement layers for each of the frames from the encoding application 103. In some embodiments, the communication module 402 may request that the encoding application 103 provide the base layer and the one or more enhancement layers that correspond to the viewing direction of the end user. In some embodiments, once the communication module 402 determines a change in the viewing direction of the end user, the communication module 402 requests one or more enhancement layers that correspond to the change in the viewing direction of the end user.

The synthesizing module 404 may include code and routines for generating a video stream. In some embodiments, the synthesizing module 404 includes a set of instructions executable by the processor 425 to generate the video stream. In some embodiments, the synthesizing module 404 is stored in the memory 427 of the computing device 400 and is accessible and executable by the processor 425.

The synthesizing module 404 generates a video stream from the base layer and, based on the viewing direction of the end user, the one or more enhancement layers. For example, if the user is looking at waves that were only associated with a base layer and no enhancement layers, the synthesizing module 404 generates the video stream by synthesizing the base layer from each of the frames. In another example, if the user is looking at a person in front of the waves, where the person is associated with two enhancement layers, the synthesizing module 404 generates the video stream from the base layer and the two enhancement layers. The synthesizing module 404 provides the video stream to the decoder 104 for decoding.

In some embodiments, the end user may change from a first viewing direction to a second viewing direction. The synthesizing module 404 may generate a second video stream from the same base layer and one or more enhancement layers that correspond to the second viewing direction. The synthesizing module 404 may provide the second video stream to the decoder 104 for decoding.

In some embodiments, the synthesizing module 404 receives information about a bandwidth level of the user device 115 associated with the end user. The synthesizing module 404 may determine a number of the one or more enhancement layers for the video stream based on the bandwidth level. For example, the synthesizing module 404 receives information that the user device 115 has a low bandwidth level. As a result, the synthesizing module 404 receives only one of multiple enhancement layers.

In some embodiments, the synthesizing module 404 prefetches one or more enhancement layers based on head-tracking data. For example, the synthesizing module 404 prefetches enhancement layers that correspond to a most common viewing direction that occurs during the viewing of the 360-degree video.

In some embodiments, the synthesizing module 404 applies the following algorithm to synthesize the video:

DATA = [ ];
FOR EACH frame in FRAMES:

READ(eBL (getView (‘eBL’, gaze)), frame) → dBL
APPEND(DATA, dBL) → DATA
FOR EACH n in N: #N available Layers of eEL (T, N)

READ (eEL (getView (‘eEL’, gaze), n), frame) → dEL
APPEND (DATA, dEL) → DATA

DO

DO
PASS DATA to VIDEO DECODER

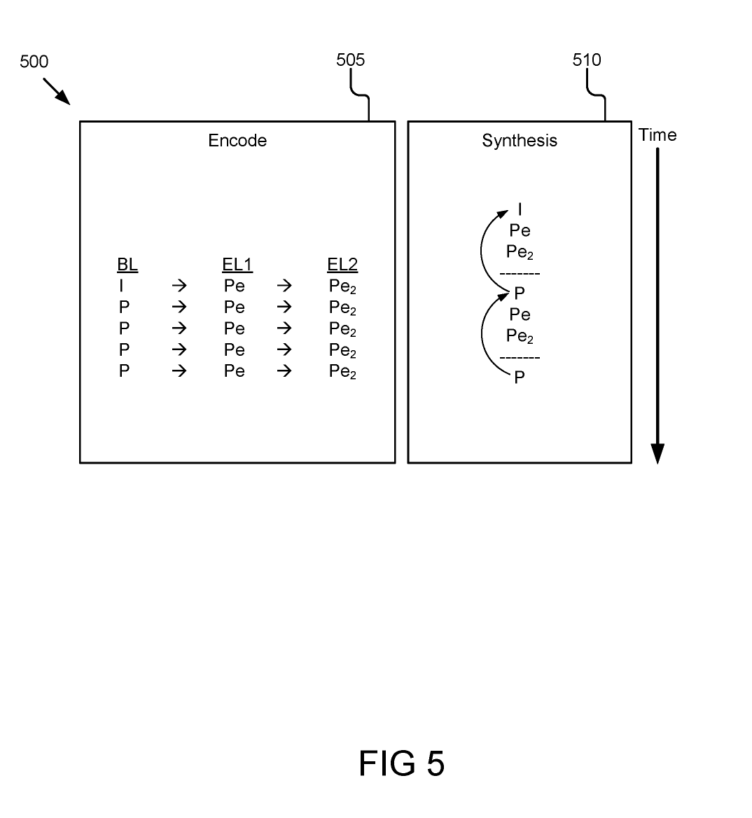

FIG. 5 illustrates an example process 500 for encoding and synthesizing virtual reality content from a 360-degree video. The process 500 includes an encoding portion 505 and a synthesizing portion 510. For the encoding portion 505, each row represents the data associated with a frame in a 360-degree video. The first column represents data associated with the base layer (BL). The second column represents data associated with the first enhancement layer (EL1). The third column represents data associated with the second enhancement layer (EL2).

For the first frame, the encoding application 103 encodes a base layer composed of an I-frame (I), a first enhancement layer composed of a P-frame (Pe), and a second enhancement layer composed of a P-frame (Pe₂). For the next frame, the encoding application 103 encodes a P-frame (P) for the base layer that references the I-frame (I), a P frame (Pe) for the first enhancement layer that references the P-frame for the base layer, and a P-frame (Pe₂) for the second enhancement layer that references the P-frame for the first enhancement layer.

For the synthesizing portion 510, the synthesizing application 112 generates a video stream by synthesizing the first frame as a combination of the I-frame and the two P-frames. The synthesizing application 112 continues this process with each subsequent frame.

Once the video stream is received by the decoder 104, the decoder 104 decodes the I-frames and the P-frames to display the video. For example, the decoder 104 displays the first frame of the video stream by decoding the I-frame (I). If the end user started viewing at the second frame, the decoder 104 would display the second frame of the video stream by decoding the I-frame (I) and the P-frame (P). However, if the end user started watching the video stream at the first frame, the decoder 104 already decoded the I-frame (I) and would only need to decode the P-frame (P) next.

If the end user starts viewing the video stream at the third frame, the decoder 104 reconstructs the base layer for the third frame by fetching the I-frame and two P-frames (P). If the end user is viewing the third frame in a viewing direction that is associated with the first enhancement layer, the decoder 104 reconstructs the third frame by fetching the I-frame, the two P-frames associated with the base layer (P), and the first P-frame (Pe) that is referencing the third frame of the base layer. If the end user is viewing the third frame in a viewing direction that is associated with both enhancement layers, the decoder 104 reconstructs the I-frame, the two P-frames associated with the base layer (P), the first P-frame (Pe) for the third frame, and the second P-frame (Pe₂) for the third frame.

Traditionally, a video stream is not made up only of I-frames because I-frames contain so much data it results in storage and bandwidth problems. For example, an end user would experience a lag in the video streaming if a video stream of I-frames was wirelessly transmitted to the user device 115. In addition, it is problematic to have a traditional video stream made up of only one I-frame and subsequent P-frames because displaying a particular frame in the video stream requires reconstructing the current frame from the I-frame and all P-frames that occur after the I-frame and up to the current frame. If an end user chose to jump ahead three seconds in the video stream, for example, this would result in a significant lag as it would require reconstruction of 400 P-frames.

Furthermore, when a user changes viewing direction, traditionally the decoder would have to reconstruct the frame by reconstructing using a new I-frame. This would similarly result in a lag in the video streaming because of the number of P-frames that would have to be reconstructed.

This problem is solved by having the base layer decoded. The encoding application 103 encodes a base layer that includes P-frames that are derivative of the base layer. As was described in Table 1, the first frame of the base layer is an I-frame (i.e., key frame) and the subsequent frames are reference frames that include a difference between the I-frame and each subsequent frame. For example, the base layer for the second frame references the changes that occurred since the base layer for the first frame and the base layer for the first frame references the changes that occurred since the I-frame.

Continuing with the example described above for FIG. 5, when an end user makes a substantial change in viewing direction, for example, by rotating 180 degrees, the decoder 104 only has the base layer information available. If the viewing direction is associated with the two enhancement layers, the decoder 104 fetches the first few P-frames for the first enhancement layer. Until the P-frames are reconstructed, the end user sees the low-resolution video associated with the base layer. This is advantageous over traditional virtual reality systems that would not able to display the video stream because the decoder would still be reconstructing P-frames and an I-frame. Once enough P-frames for the first enhancement layer have been buffered by the decoder 104, the decoder 104 fetches P-frames for the second enhancement layer. In some embodiments, because it takes the end user about 40 ms to refocus on the video stream, the end user may not notice a decrease in quality as the decoder 104 fetches the corresponding enhancement layers.

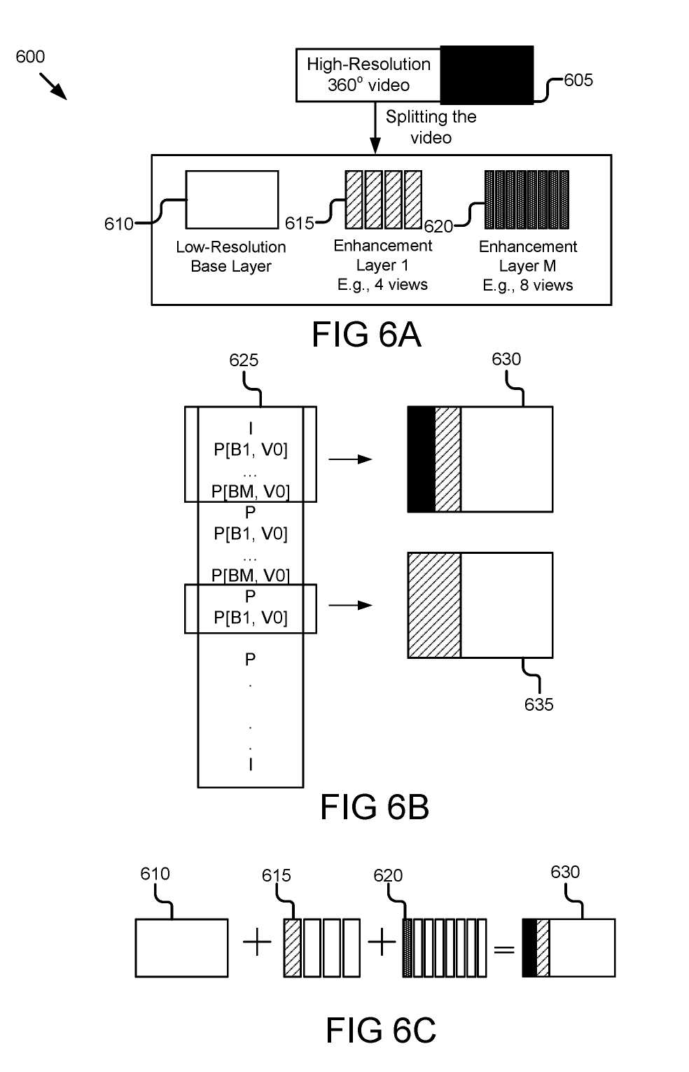

FIGS. 6A-6C illustrate another example process 600 for encoding and synthesizing virtual reality content from a 360-degree video according to some embodiments. In FIG. 6A, the encoding application 103 receives a high-resolution 360-degree video as represented by the black rectangle 605. The encoding application 103 splits the video into a low-resolution base layer 610 that includes all views for a frame, an enhancement layer 1 615 that includes four views, and an enhancement layer M 620 that includes eight views.

FIG. 6B illustrates the encoded frames 625 that the synthesizing application 112 synthesizes into a bit stream for a particular view. For example, the first frame 630 is synthesized from the base layer (I), the enhancement layer 1 (P[BM, V0]), and the enhancement layer M (P[BM, V0]). The first frame 630 is composed of ⅛ of the high-resolution 360-degree video because ⅛ of the frame includes the base layer 610, the enhancement layer 1 615, and the enhancement layer M 620. The first frame 630 is also composed of ⅛ of an enhanced view because ⅛ of the frame includes the base layer 610 and the enhancement layer 1 615. Lastly, ¾ of the first frame 630 is composed of only the base layer 610. A subsequent frame 635 is composed of ¼ of the enhancement layer 1 615 and ¾ of the base layer 610.

FIG. 6C illustrates reconstruction of the first view of the first frame 630 of the 360-degree video. The synthesizing application 112 reconstructs a first view of the first frame 630 from the base layer 610, ¼ of the enhancement layer 1 615, and ⅛ of the enhancement layer M 620. As a result of the reconstruction, ⅛ of the first frame looks like the high-resolution 360-degree video, ⅛ of the first frame includes a first level enhancement from the base layer, and ¾ of the first frame is displayed with the low-resolution base layer 610.

The user interface module 406 may include code and routines for generating a user interface. In some embodiments, the user interface module 406 includes a set of instructions executable by the processor 225 to generate the user interface. In some embodiments, the user interface module 406 is stored in the memory 227 of the computing device 200 and is accessible and executable by the processor 225.

In some embodiments, the user interface module 406 may generate a user interface that includes options for selecting a 360-degree video to display, a viewing device 125 for displaying the 360-degree video, etc. The user interface module 406 may also generate a user interface that includes system options, such as volume, in-application purchases, user profile information, etc.

### Example Flow Diagram

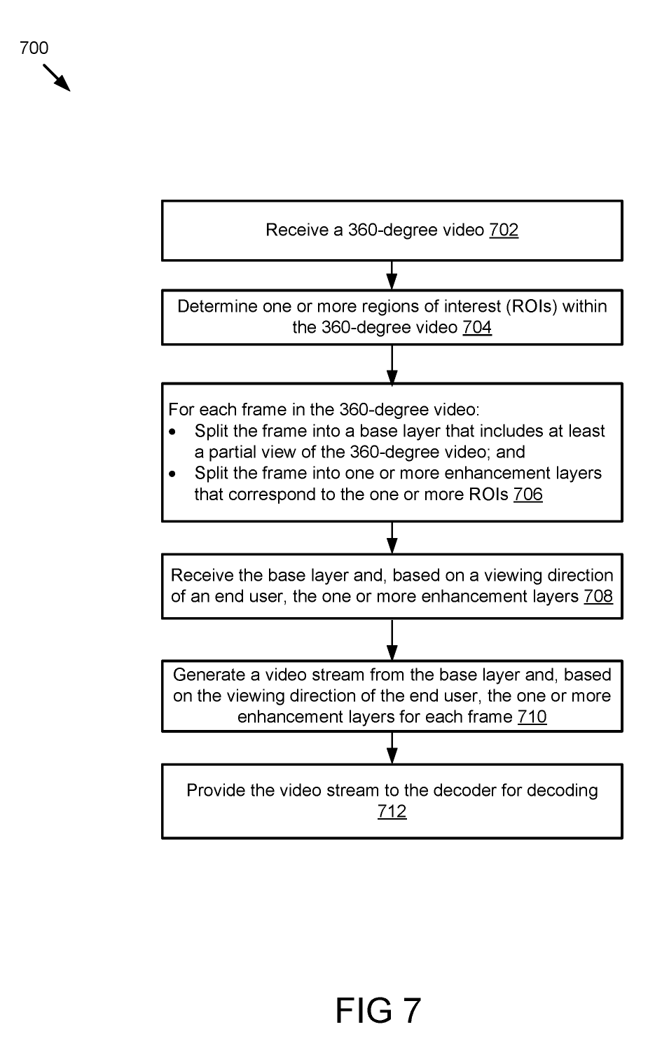

FIG. 7 illustrates an example flow diagram 700 for generating a video stream from a 360-degree video according to some embodiments. The steps in FIG. 7 may be performed by the encoding application 103 stored on the video streaming server 101, the synthesizing application 112 stored on the user device 115, or a combination of the encoding application 103 stored on the video streaming server 101 and the synthesizing application 112 stored on the user device 115.

At block 702, a 360-degree video is received, for example, by the encoding application 103. At block 704, one or more ROIs are determined within the 360-degree video, for example, by the encoding application 103. The ROIs may be determined based on views within the 360-degree video, head-tracking data, or object recognition. At block 706, for each frame in the 360-degree video, the frame is split into a base layer that includes at least a partial view of the 360-degree video and the frame is split into one or more enhancement layers that correspond to the one or more ROIs, for example, by the encoding application 103. The encoding application 103 may transmit the base layer and, based on a viewing direction of the end user, one or more enhancement layers to a synthesizing application 112.

At block 708, the base layer and, based on the viewing direction of the end user, the one or more enhancement layers are received, for example, by the synthesizing application 112. In some embodiments, the viewing direction is received from the viewing device 125. The one or more enhancement layers may be received if the end user is looking in a viewing direction associated with the one or more enhancement layers.

At block 710, a video stream is generated from the base layer and, based on the viewing direction of the end user, the one or more enhancement layers, for example, by the synthesizing application 112. For example, the synthesizing application 112 generates a bit stream from the base layer and the one or more enhancement layers. At block 712, the video stream, is provided to the decoder 104 for decoding, for example, by the synthesizing application 112.

The separation of various components and servers in the embodiments described herein should not be understood as requiring such separation in all embodiments, and it should be understood that the described components and servers may generally be integrated together in a single component or server. Additions, modifications, or omissions may be made to the illustrated embodiment without departing from the scope of the present disclosure, as will be appreciated in view of the disclosure.

Embodiments described herein contemplate various additions, modifications, and/or omissions to the above-described panoptic virtual presence system, which has been described by way of example only. Accordingly, the above-described camera system should not be construed as limiting. For example, the camera system described with respect to FIG. 1 below may include additional and/or different components or functionality than described above without departing from the scope of the disclosure.

Embodiments described herein may be implemented using computer-readable media for carrying or having computer-executable instructions or data structures stored thereon. Such computer-readable media may be any available media that may be accessed by a general purpose or special purpose computer. By way of example, and not limitation, such computer-readable media may include tangible computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general purpose or special purpose computer. Combinations of the above may also be included within the scope of computer-readable media.

Computer-executable instructions comprise, for example, instructions and data which cause a general purpose computer, special purpose computer, or special purpose processing device (e.g., one or more processors) to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the terms “module” or “component” may refer to specific hardware embodiments configured to perform the operations of the module or component and/or software objects or software routines that may be stored on and/or executed by general purpose hardware (e.g., computer-readable media, processing devices, etc.) of the computing system. In some embodiments, the different components, modules, engines, and services described herein may be implemented as objects or processes that execute on the computing system (e.g., as separate threads). While some of the system and methods described herein are generally described as being implemented in software (stored on and/or executed by general purpose hardware), specific hardware embodiments or a combination of software and specific hardware embodiments are also possible and contemplated. In this description, a “computing entity” may be any computing system as previously defined herein, or any module or combination of modulates running on a computing system.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the inventions have been described in detail, it may be understood that the various changes, substitutions, and alterations could be made hereto without departing from the spirit and scope of the invention.

What is claimed is:

1. A computer-implemented method comprising:
receiving a 360-degree video;
determining one or more regions of interest (ROIs) within the 360-degree video;
for each frame in the 360-degree video:
splitting the frame into a base layer that includes at least a partial view of the 360-degree video; and
splitting the frame into one or more enhancement layers that correspond to the one or more ROIs;
receiving the base layer and, based on a viewing direction of an end user, the one or more enhancement layers;
generating a video stream from the base layer and, based on the viewing direction of the end user, the one or more enhancement layers; and
providing the video stream to a decoder for decoding.

2. The method of claim 1, further comprising encoding a first frame of the 360-degree video as a key frame.

3. The method of claim 2, wherein encoding the first frame of the 360-degree video further includes encoding a first enhancement layer of the one or more enhancement layers as a reference frame that references the base layer.

4. The method of claim 1, wherein the base layer and the one or more enhancement layers each include two or more views of the 360-degree video.

5. The method of claim 4, wherein a first view of the 360-degree video is associated with the base layer and one enhancement layer and a second view of the 360-degree video is associated with the base layer and two enhancement layers.

6. The method of claim 5, wherein the first view is a forward view and the second view is a backside view.

7. The method of claim 1, wherein the viewing direction is a first viewing direction, the video stream is a first viewing stream, the one or more enhancement layers are one or more first enhancement layers that correspond to the first viewing direction, and further comprising:
based on a second viewing direction of the end user, generating a second video stream from the base layer and one or more second enhancement layers; and
providing the second video stream to the decoder for decoding.

8. The method of claim 1, wherein splitting the frame is based on at least one of spatial filtering, frequency filtering, and wavelet transformation.

9. The method of claim 1, further comprising prefetching the one or more enhancement layers based on head-tracking data.

10. The method of claim 9, wherein the head-tracking data describes a most-common viewing direction.

11. A system comprising:
one or more processors coupled to a memory;
an encoding application stored in the memory and executable by the one or more processors, the encoding application operable to:
receive a 360-degree video;
determine one or more regions of interest (ROI) within the 360-degree video; and
for each frame in the 360-degree video:
split the frame into a base layer that includes at least a partial view of the 360-degree video; and
split the frame into one or more enhancement layers that correspond to the one or more ROIs.

12. The system of claim 11, wherein the encoding application is further configured to encode a first frame of the 360-degree video as a key frame.

13. The system of claim 12, wherein encoding the first frame of the 360-degree video further includes encoding a first enhancement layer of the one or more enhancement layers as a reference frame that references the base layer.

14. The system of claim 11, wherein the one or more enhancement layers include a first enhancement layer and a second enhancement layer, the first enhancement layer references the base layer, and the second enhancement layer references the first enhancement layer.

15. The system of claim 11, further comprising a synthesizing application stored in the memory and executable by the one or more processors, the encoding application operable to:
receive the base layer and, based on a viewing direction of an end user, the one or more enhancement layers;
generate a video stream from the base layer and, based on the viewing direction of the end user, the one or more enhancement layers; and
provide the video stream to a decoder for decoding.

16. The system of claim 11, wherein splitting the frame is based on at least one of spatial filtering, frequency filtering, and wavelet transformation.

17. A non-transitory computer storage medium encoded with a computer program, the computer program comprising instructions that, when executed by one or more processors, cause the one or more processors to perform operations comprising:
receiving a base layer;
generating a video stream from the base layer; and
providing the video stream to a decoder for decoding.

18. The computer storage medium of claim 17, wherein receiving the base layer further includes receiving one or more enhancement layers and the video stream is generated from the base layer and the one or more enhancement layers based on a viewing direction of an end user.

19. The computer storage medium of claim 18, wherein the operations further comprise prefetching the one or more enhancement layers based on head-tracking data.

20. The computer storage medium of claim 19, wherein the head-tracking data describes a most-common viewing direction.
